(19) United States
(12) Patent Application Publication
(10) Pub. No.: US 2009/0008107 A1
(43) Pub. Date: Jan. 8, 2009

(54) Stalk and root eliminator

(76) Inventor: Ronald Dale Howard, Warwick, GA (US)

Correspondence Address: WILEY HORTON, 215 SOUTH MONROE STREET, 2ND FLOOR, TALLAHASSEE, FL, 32301, US

(21) Appl. No.: 12/079,857

(22) Filed: Mar. 28, 2008

Related U.S. Application Data
(60) Provisional application No. 60/958,032, filed on Jul. 2, 2007.

(51) Int. Cl. A01D 25/04

(52) U.S. Cl. 171/58

(57) ABSTRACT

A stalk and root eliminator for efficiently cutting, uprooting, and lifting vegetation from the soil. The stalk and root eliminator is able to accomplish each of these functions in a single pass, greatly reducing the time it takes to clear a field. The stalk and root eliminator includes a front hitch mount for coupling the chassis of the stalk and root eliminator to a tractor, a cutting device, a series of plows, and a rotary picker aligned with each of the plows.

### CROSS-REFERENCES TO RELATED APPLICATIONS

This application claims the benefit of the filing date of U.S. Application No. 60/958,032 which names the same inventor. This application was filed on Jul. 2, 2007.

### STATEMENT REGARDING FEDERALLY SPONSORED RESEARCH OR DEVELOPMENT

Not applicable

### MICROFICHE APPENDIX

Not Applicable

### BACKGROUND OF THE INVENTION

1. Field of the Invention

This invention relates to the field of farm equipment. More specifically, the present invention comprises a stalk and root eliminator capable of efficiently cutting, uprooting, and lifting vegetation out of the soil.

2. Description of the Related Art

Various harvesting equipment are known in the prior art for harvesting crops and other vegetation. In some cases, it is desirable to separate the vegetation completely (roots and stalk) from the soil. Conventionally, this has required different harvesting tools to be employed in successive “passes” across the field. For example, a tractor operator may first utilize a cutting implement to remove the top of a stalk. The operator may then unhitch the cutting implement from the tractor and attach a plow in place of the cutting implement. The operator may then make another pass across the field with the plow to uproot the remainder of the stalk. The operator may then attach yet another implement to the tractor to harvest or remove the vegetation from the field. Thus, three or more passes are usually required to clear a field of vegetation.

### BRIEF SUMMARY OF THE PRESENT INVENTION

The present invention comprises a stalk and root eliminator for efficiently cutting, uprooting, and lifting vegetation from the soil. The stalk and root eliminator is able to accomplish each of these functions in a single pass, greatly reducing the time it takes to clear a field. The stalk and root eliminator includes a front hitch mount for coupling the chassis of the stalk and root eliminator to a tractor. One or more adjustable front wheels and rear wheels are provided on the chassis. A cutter housing is attached beneath the chassis. The cutter housing contains a blade drive shaft and a plurality of cutting blades attached thereto. The blade drive shaft has a central axis which is perpendicular to the direction of travel of the stalk and root eliminator. The blade drive shaft may be driven by the tractor's power take-off or a separate motor.

Multiple plows are attached to the chassis rearward of the cutter housing. Each plow is attached to the chassis by a mounting bracket. Each plow has a beam extending beneath the chassis of the stalk and root eliminator and a plow bottom adapted to penetrate and till a layer of soil. Various plow bottoms may be used including chisel or mouldboard varieties.

A series of rotary pickers are attached to the chassis rearward of the plows. Each rotary picker has a plurality of pick fingers which comb through the plowed soil and lift the vegetation to the surface. Each rotary picker is mounted on a shaft. This allows the rotary picker to naturally rotate as it is pulled through the top layer of soil.

### BRIEF DESCRIPTION OF THE SEVERAL VIEWS OF THE DRAWINGS

FIG. 1 is a perspective view, illustrating the present invention.

FIG. 2 is a front view, illustrating the present invention.

FIG. 3 is a bottom view, illustrating the present invention.

FIG. 4 is a rear view, illustrating the present invention.

FIG. 5 is a detail view, illustrating a rotary picker

FIG. 6 is a detail view, illustrating a cutting blade.

FIG. 7 is a side view, illustrating a cutting blade.

FIG. 8 is a side view, illustrating the operation of the present invention.

FIG. 9 is a perspective view, illustrating a cutting blade.

FIG. 10 is a detail view, illustrating a harrow.

### REFERENCE NUMERALS IN THE DRAWINGS

| | | | |
|---|---|---|---|
| 10 | stalk and root eliminator | 12 | chassis |
| 14 | 3-point linkage | 16 | cutting manifold |
| 18 | drive shaft | 20 | opening |
| 22 | gearbox | 24 | wheel |
| 26 | post | 28 | plow |
| 30 | beam | 32 | rotary picker |
| 34 | extender arm | 36 | wheel |
| 38 | post | 40 | cutting blade |
| 42 | gearbox | 44 | cut vegetation |
| 46 | plowed vegetation | 48 | separated vegetation |
| 50 | uncut vegetation | 52 | shaft |
| 54 | shaft | 56 | transmission |
| 58 | blade shaft | 60 | flaps |
| 62 | swivel shaft | 64 | pick fingers |
| 66 | shaft | 68 | L-shaped blades |
| 70 | bolts | 72 | mounting bore |
| 74 | mounting plate | 76 | flanges |
| 78 | nuts | 80 | post receiver |
| 82 | harrow | 84 | harrow disks |
| 86 | plate | 88 | collar |
| 90 | cutting blade | 92 | keyway |
| 94 | blade | 96 | bolts |
| 98 | leading edge | 100 | trailing edge |
| 102 | flange | | |

### DETAILED DESCRIPTION OF THE INVENTION

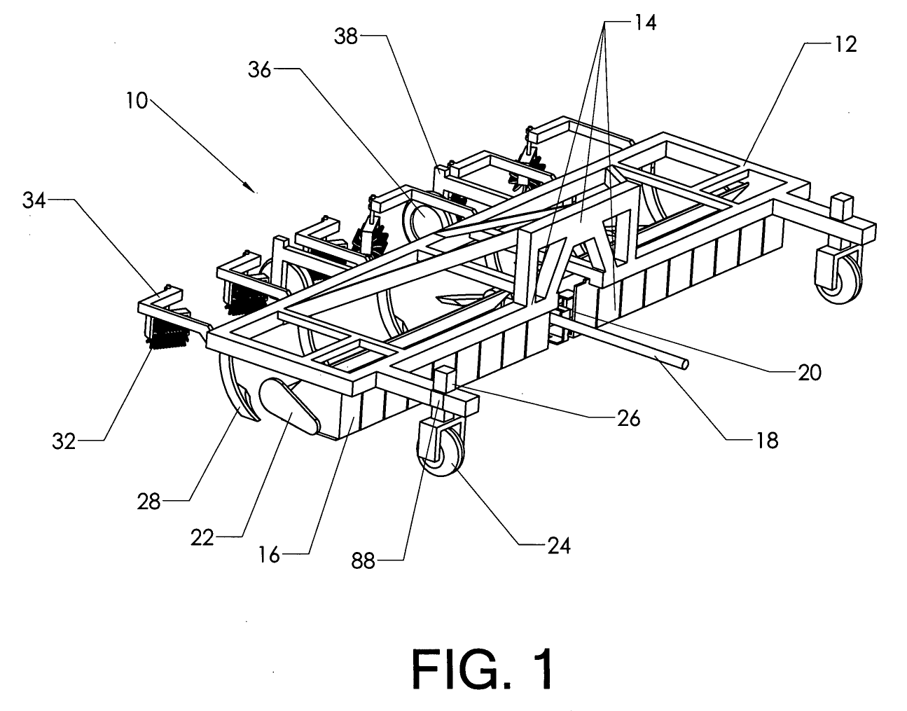

The present invention, stalk and root eliminator 10, is illustrated in FIG. 1. Stalk and root eliminator 10 generally includes chassis 12 which may be attached behind a tractor by 3-point linkage 14. One or more front wheels 24 and rear wheels 36 are attached to chassis 12. The height of chassis 12 may be adjusted relative to front wheels 24 and rear wheels 36 to set a maximum plow depth. Front wheel 24 is attached to chassis 12 by post 26 which is height-adjustably mounted within post receiver 80. Similarly, rear wheel 36 is attached to chassis by post 38 which is also situated within a height-adjustable receiver.

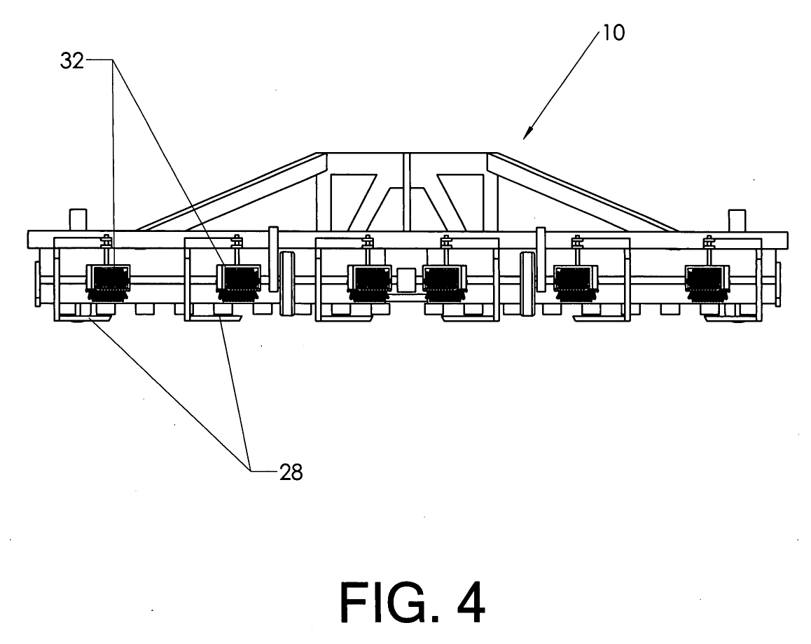

Cutting manifold 16 is attached beneath chassis 12. Cutting manifold 16 houses a cutting device for cutting vegetation such as cotton stalks. The cutting device may be driven by the power take-off of the tractor via drive shaft 18 or by a separate motor. A series of plows 28 are attached to chassis 12 rearward of cutting manifold 16. Each plow 28 is attached to beam 30 which extends beneath chassis 12. Rotary picker 32 is attached rearward of plow 28 on chassis 12 by extender arm 34. As shown more clearly in the rear view of stalk and root eliminator 10 in FIG. 4, each plow 28 has a corresponding rotary picker 32. The purpose of this linear arrangement of the cutting device, plows, and rotary pickers will be described in greater detail subsequently.

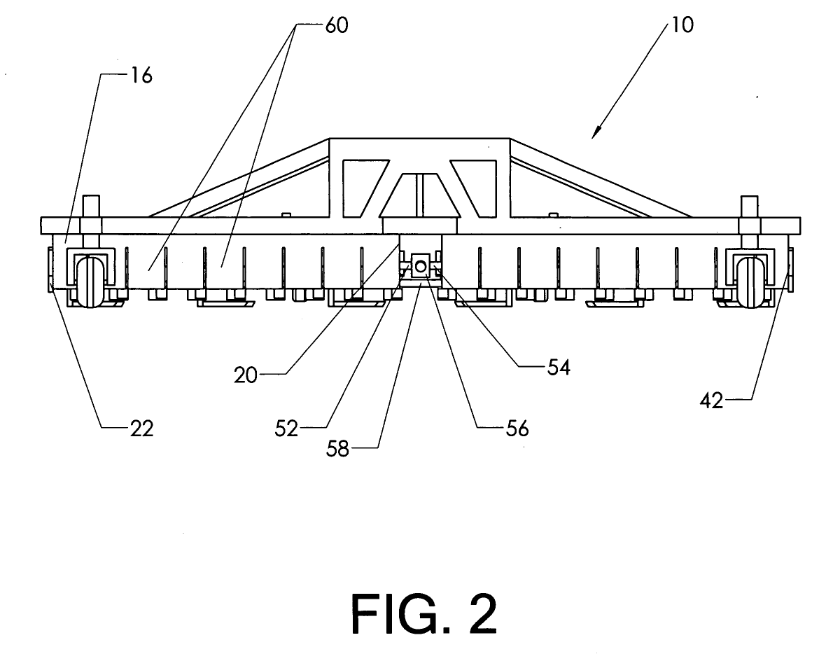

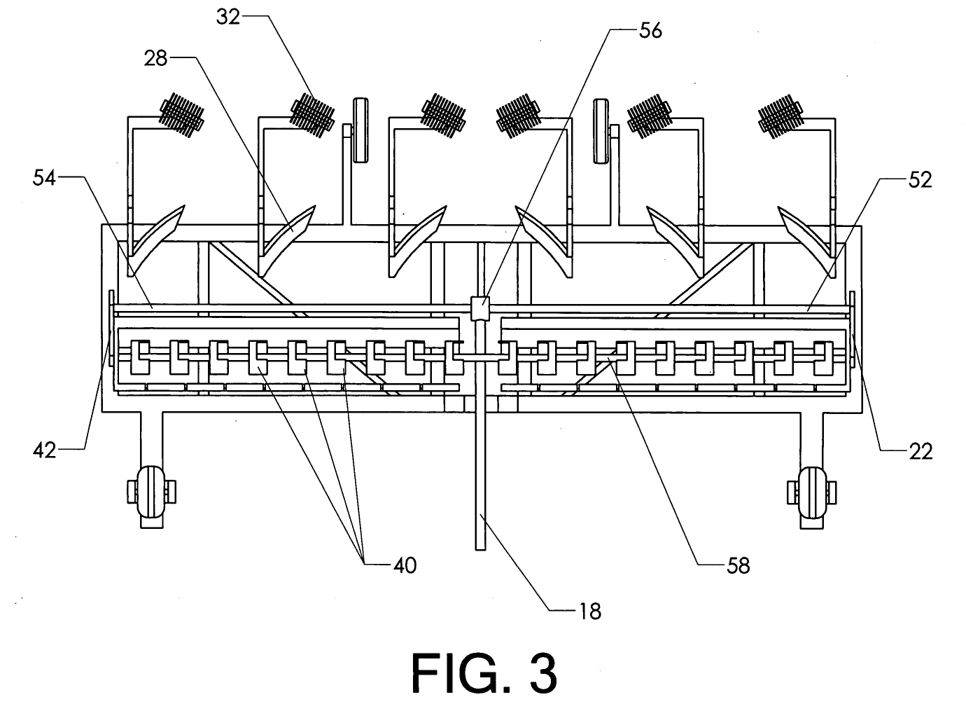

A front view of stalk and root eliminator 10 is illustrated in FIG. 2. Flaps 60 cover the front of cutting manifold 16 and prevent cut vegetation and other objects from being kicked-back toward the operator of the tractor. Flaps 60 are made of a flexible material, however, to permit vegetation to pass between and under flaps 60 to be cut. Opening 20 is provided in the middle of cutting manifold 16 for receiving drive shaft 18 (see FIG. 1). Referring back to FIG. 2, drive shaft 18 engages transmission 56 which transfers the torque from drive shaft 18 to shafts 52 and 54. Shafts 52 and 54 transmit power to blade shaft 58 via gearboxes 22 and 42. This powertrain is illustrated more clearly in FIG. 3. The reader will note that a series of cutting blades 40 are attached to blade shaft 58. Each cutting blade 40 rotates with blade shaft 58 along a horizontal axis of rotation which is substantially perpendicular to the direction of travel of the tractor.

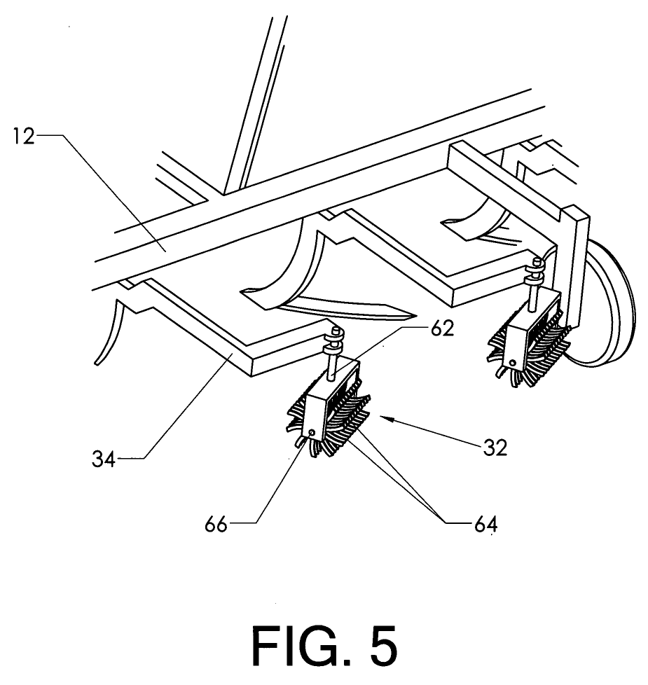

FIG. 5 is a detail view of rotary picker 32. Each rotary picker 32 is attached to chassis 12 by extender arm 34. Rotary picker 32 is attached below extender arm 34 by swivel shaft 62 and includes a plurality of pick fingers 64 which freely rotate about shaft 66. Rotary picker 32 separates stalks and roots from the soil after plow 28 passes through the soil ahead of rotary picker 32. Pick fingers 64 roll and “comb” through the plowed soil and separate the vegetation from the soil. Although not shown in FIG. 5, extender arm 34 may be removably attached to chassis 12, so that rotary pickers 32 may be removed from chassis 12 when desired.

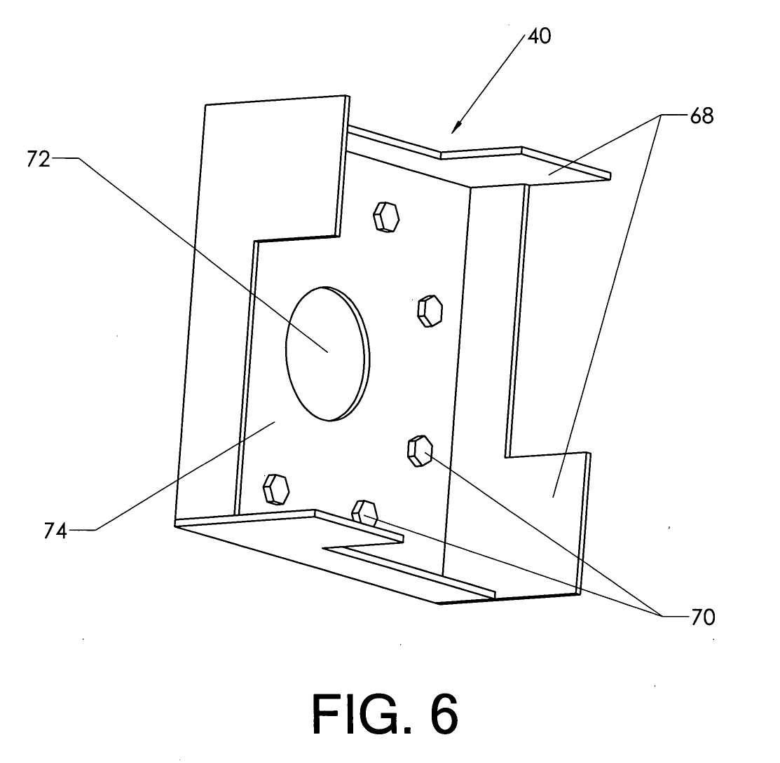

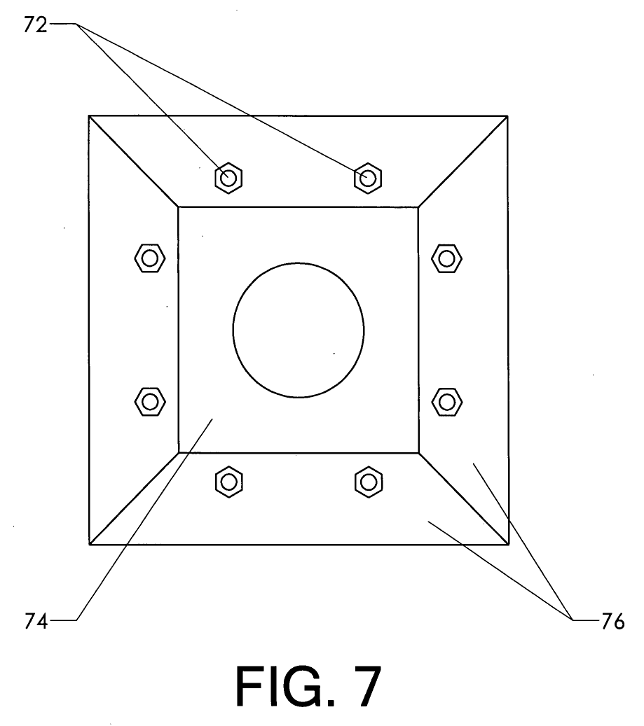

FIG. 6 and FIG. 7 illustrate cutting blade 40 which may be used with stalk and root eliminator 10. Four L-shaped blades 68 are attached to mounting plate 74 by bolts 70. FIG. 7 shows the opposite side of cutting blade 40. Each L-shaped blade 68 has flange 76 that wraps around mounting plate 74. Bolts 70 pass through mounting plate 74 and flange 76 and the assembly is secured together with nuts 78. If one of L-shaped blades 68 is bent or otherwise damaged during cutting, it is only necessary to replace the part that is bent—which can be easily unbolted from mounting plate 74.

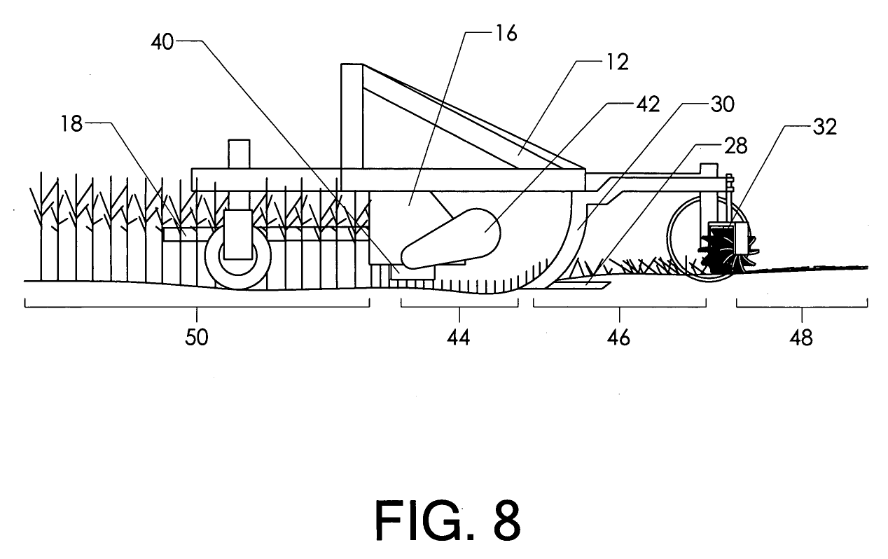

FIG. 8 illustrates the operation of stalk and root eliminator 10. Stalk and root eliminator 10 is pulled behind a tractor across uncut vegetation 50. The top portion of the vegetation passes into cutting manifold 16 where it is chopped off by cutting blades 40 leaving cut vegetation 44. Plow 28 passes through the soil behind cutting manifold 16 and loosens the roots of cut vegetation 44 leaving behind an area of plowed vegetation 46. Rotary pickers 32 then comb through plowed vegetations 46 and lift the vegetation to the surface of the soil, leaving behind an area of separated vegetation 48.

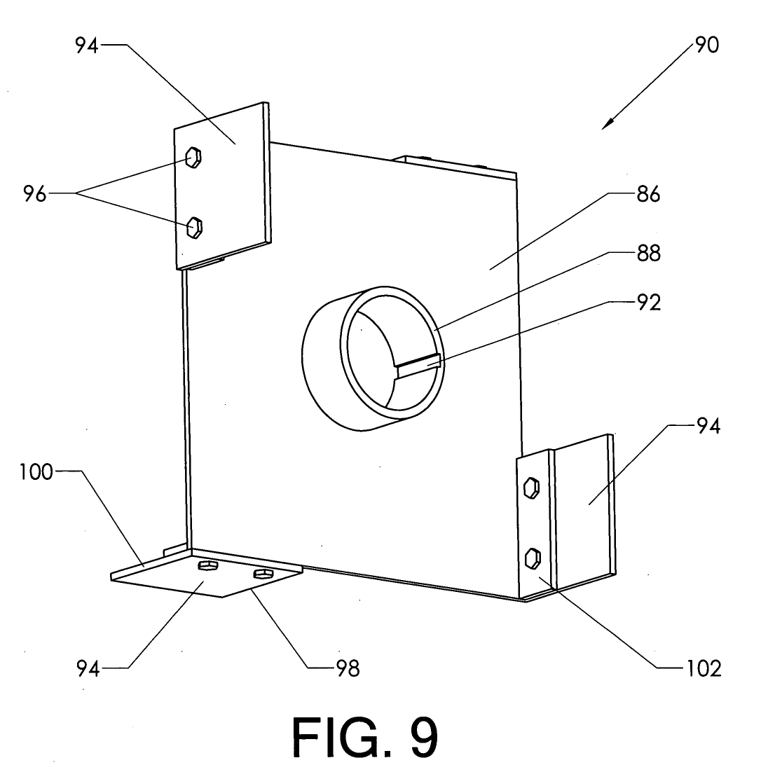

FIG. 9 illustrates how a harrow may be substituted for the rotary picker. Harrow 82 is attached to chassis 12 like—rotary picker 32—via extender arm 34 and swivel shaft 62. Harrow disks 84 rotate about shaft 66 when harrow 82 is allowed to roll on the ground. Those that are skilled in the art will appreciate that harrow disks 84 will break up clods and lumps of soil created by the plows, thus providing a finer soil finish that is more suitable for seeding and planting operations.

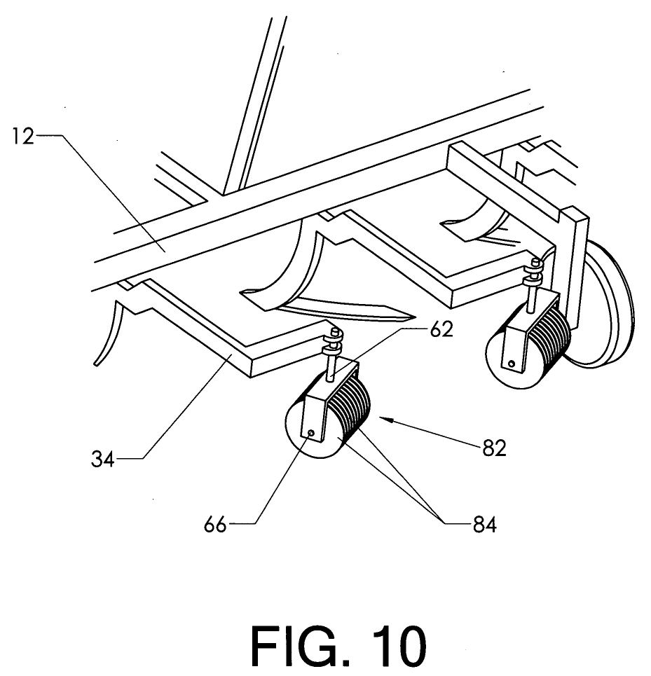

FIG. 10 illustrates yet another cutting blade that may be employed on stalk and root eliminator 10. Cutting blade 90 includes plate 86 having collar 88 for receiving the blade drive shaft. Keyway 92 is provided to allow cutting blade 90 to be locked in place on the blade drive shaft. Blades 94 are attached to flanges 102 with bolts 96 or other fasteners. Blades 94 extend from plate 86 parallel to the blade drive shaft. As such, blades 94 extend in both the positive and negative z direction when plate 86 lies in the x-y plane. Each blade 94 includes both two cutting edges—leading edge 98 and trailing edge 100. When oriented as shown in FIG. 9, only leading edge 98 cuts the vegetation. Cutting blade 90 may be reversed on the blade drive shaft from time to time such that trailing edge 100 may be used to cut the vegetation. Thus, if collar 88 normally extends in the positive z direction relative to plate 86, cutting blade 90 may be turned such that collar 88 extends in the negative z direction. This may be useful when leading edge 98 begins to dull after extended use. When leading edge 98 and trailing edge 100 are both dull, the user can replace blade 94 or sharpen the cutting edges.

With the present invention now more thoroughly described, the reader may now appreciate the various features of the present invention which allows stalk and root eliminator 10 to transform a field of rooted vegetation into a field of “separated” vegetation in a single pass. Referring back to FIG. 5, the reader will now appreciate that swivel shaft 62 allows rotary picker 32 to turn with the tractor (such as when executing a U-turn) so as not to stress pick fingers 64. Pick fingers 64 are curved to induce angular rotation of rotary picker 32 when rolled through the plowed soil. The direction of angular rotation is preferably the same direction as the rotation of the wheels of the tractor. The curvature also helps lift the vegetation as each pick finger 64 rotates out of the soil.

The preceding description contains significant detail regarding the novel aspects of the present invention. It should not be construed, however, as limiting the scope of the invention but rather as providing illustrations of the preferred embodiments of the invention. Thus, the scope of the invention should be fixed by the following claims, rather than by the examples given.

What is claimed is:

1. A stalk and root eliminator for separating a vegetation from a soil, said stalk and root eliminator pulled behind a tractor traveling in a direction of travel, said tractor having a plurality of wheels rotating in an angular direction when traveling in said direction of travel, said stalk and root eliminator comprising:
a. a chassis;
b. a coupling configured to attach said chassis to said tractor;
c. a cutting device attached to said chassis having
i. a shaft rotating about an axis of rotation, said axis of rotation perpendicular to said direction of travel;
ii. a plurality of cutting blades attached to said shaft;
d. a plurality of plowing devices attached to said chassis rearward of said cutting device, each of said plurality of plowing devices having
i. a beam extending beneath said chassis;
ii. a plow bottom configured to penetrate and till a top layer of soil;
e. a plurality of rotary pickers attached to said chassis rearward of said plurality of plowing devices, each of said rotary pickers adapted to rotate about a shaft and lift said vegetation from said top layer of soil when said stalk and root eliminator is pulled behind said tractor.

2. The stalk and root eliminator of claim 1, said cutting device further including:
a. a cutting manifold housing said shaft and plurality of cutting blades; and
b. a powertrain configured to transfer mechanical power from said tractor to said shaft of said cutting device.

3. The stalk and root eliminator of claim 1, each of said rotary pickers including a vertical swivel shaft attaching said rotary picker to said chassis, said vertical swivel shaft having a vertical axis of rotation.

4. The stalk and root eliminator of claim 1, each of said rotary pickers including a plurality of pick fingers attached to a horizontal shaft, said horizontal shaft having a horizontal axis of rotation.

5. The stalk and root eliminator of claim 4, each of said plurality of pick fingers having a curvature configured to induce said pick finger to rotate in said angular direction of said wheels of said tractor.

6. The stalk and root eliminator of claim 1, wherein each of said plowing devices is associated with one of said plurality of rotary pickers, wherein said one of said plurality of rotary pickers and said associated plowing device are aligned in a linear relationship along said direction of travel.

7. A stalk and root eliminator for separating a vegetation from a soil, said stalk and root eliminator pulled behind a tractor traveling in a direction of travel, said tractor having a plurality of wheels rotating in an angular direction when traveling in said direction of travel, said stalk and root eliminator comprising:
a. a chassis;
b. a coupling configured to attach said chassis to said tractor;
c. a cutting device attached to said chassis having
i. a shaft rotating about an axis of rotation;
ii. a plurality of cutting blades attached to said shaft;
d. a plurality of plowing devices attached to said chassis rearward of said cutting device, each of said plurality of plowing devices having
i. a beam extending beneath said chassis;
ii. a plow bottom configured to penetrate and till a top layer of soil;
e. a plurality of rotary pickers attached to said chassis rearward of said plurality of plowing devices, each of said rotary pickers adapted to rotate about a shaft and lift said vegetation from said top layer of soil when said stalk and root eliminator is pulled behind said tractor;
f. wherein each of said plowing devices is associated with one of said plurality of rotary pickers, wherein said one of said plurality of rotary pickers and said associated plowing bottom are aligned in a linear relationship along said direction of travel.

8. The stalk and root eliminator of claim 7, said cutting device further including:
a. a cutting manifold housing said shaft and plurality of cutting blades; and
b. a powertrain configured to transfer mechanical power from said tractor to said shaft of said cutting device.

9. The stalk and root eliminator of claim 7, each of said rotary pickers including a vertical swivel shaft attaching said rotary picker to said chassis, said vertical swivel shaft having a vertical axis of rotation.

10. The stalk and root eliminator of claim 7, each of said rotary pickers including a plurality of pick fingers attached to a horizontal shaft, said horizontal shaft having a horizontal axis of rotation.

11. The stalk and root eliminator of claim 10, each of said plurality of pick fingers having a curvature configured to induce said pick finger to rotate in said angular direction of said wheels of said tractor.

12. A stalk and root eliminator for separating a vegetation from a soil, said stalk and root eliminator pulled behind a tractor traveling in a direction of travel, said tractor having a plurality of wheels rotating in an angular direction when traveling in said direction of travel, said stalk and root eliminator comprising:
a. a chassis;
b. a coupling configured to attach said chassis to said tractor;
c. a cutting device attached to said chassis having
i. a shaft rotating about an axis of rotation;
ii. a plurality of cutting blades attached to said shaft;
d. a plurality of plowing devices attached to said chassis rearward of said cutting device, each of said plurality of plowing devices having
i. a beam extending beneath said chassis;
ii. a plow bottom configured to penetrate and till a top layer of soil;
e. a plurality of rotary devices attached to said chassis rearward of said plurality of plowing devices, each of said rotary devices adapted to rotate about a shaft and prepare said top layer of soil for planting when said stalk and root eliminator is pulled behind said tractor;
f. wherein said stalk and root eliminator is configured to cut, plow, and prepare said soil for planting with a single pass of said stalk and root eliminator.

13. The stalk and root eliminator of claim 12, said cutting device further including:
a. a cutting manifold housing said shaft and plurality of cutting blades; and
b. a powertrain configured to transfer mechanical power from said tractor to said shaft of said cutting device.

14. The stalk and root eliminator of claim 12, each of said rotary devices including a vertical swivel shaft attaching said rotary device to said chassis, said vertical swivel shaft having a vertical axis of rotation.

15. The stalk and root eliminator of claim 12, each of said rotary devices including a plurality of pick fingers attached to a horizontal shaft, said horizontal shaft having a horizontal axis of rotation.

16. The stalk and root eliminator of claim 15, each of said plurality of pick fingers having a curvature configured to induce said pick finger to rotate in said angular direction of said wheels of said tractor.

17. The stalk and root eliminator of claim 12, wherein each of said plowing devices is associated with one of said plurality of rotary devices, wherein said one of said plurality of rotary devices and said associated plowing device are aligned in a linear relationship along said direction of travel.

18. The stalk and root eliminator of claim 12, wherein said axis of rotation of said shaft of said cutting device is perpendicular to said direction of travel.
